(19) United States
(12) Patent Application Publication
(10) Pub. No.: US 2011/0128258 A1
(43) Pub. Date: Jun. 2, 2011

(54) Mouse Pen

(76) Inventor: Hui-Hu Liang, Chang Hua Hsien (TW)

(21) Appl. No.: 12/628,023

(22) Filed: Nov. 30, 2009

(51) Int. Cl. G09G 1/00

(52) U.S. Cl. 345/180

(57) ABSTRACT

A mouse pen includes a pen pipe having a touch device with a touch board module and an up-down event module, and the controlling circuit mainly controls a circuit board with a micro processor as well as connects to the battery module, the touch device, and a detective device. While moving the pen pipe, the detective module detects signals on a moving track; thence the touch board module and the up-down event module would affect an auxiliary function and executive command. After processed by a processor, signals are wirelessly transmitted to an outer electronic device for controlling the cursor and other related operations on a screen.

### BACKGROUND OF THE INVENTION

1. Field of the Invention

The present invention relates to a mouse pen utilizing a detective module installed in a track space to detect moving signals. An auxiliary function and an executive command, respectively provided by a touch board module that is engaged with an accommodation and by an up-down event module, would be further processed by a circuit board with a micro processor. Thereby, afore function and command could be wirelessly transmitted to an outer electronic device for further controlling a cursor and other related operations on a screen.

2. Description of the Related Art

Generally, a mouse could be roughly classified into mechanical mouse and optical mouse. The former utilizes a trackball brought by the mouse and moved by a user, so that a raster plate could be rotated. Accordingly, two light sensors could generate different pulse waves to count the motivation in tracks of an X axis and a Y axis. Subsequently, a counting result could be transmitted to the computer. Comparatively, the optical mouse utilizes a ultrared sensor installed at a button of the mouse; whereby, an automatic scan would be executed by a certain period. Thence, a processor would compare two scanned images to decide the moving position of a coordinate. Moreover, the optical mouse could move on many objects, so that a handy operation of the corresponding cursor is also achieved.

### SUMMARY OF THE INVENTION

### 1. The Problems to Solve

A. The conventional mouse is mostly controlled by user's palm lying on a case thereof, and the moving direction of a corresponding cursor is controlled by user arbitrarily moving the mouse on a flat surface. Wherein, click buttons as well as a roller on the mouse could serve other auxiliary function or executive command. However, such a mouse requires a certain area to perform the motion thereof. Thus, for being applied to a notebook or a portable device with a micro computer, an additional flat surface is adversely required by the mouse. Further, with a certain height and size, the conventional mouse is not suitable for portability.
B. The conventional mouse has been improved from wired operation to wireless operation. Thus, the inconvenience generated by arranging the wire of the wired input device is already settled. Such input device provides with a receiver connected to the host and supplies it with electricity. Accordingly, batteries are adopted for giving continuous electricity to the mouse, and an input signal emitted from the mouse would be transmitted to the receiver. Herein, users still have to dispose the mouse at either side of a keyboard. Thus, users readily collide with the mouse and the mouse would fall. As a result, the mouse is facilely damaged or broken.

### 2. The Objects of the Present Invention

A. One object of the present invention is to provide a mouse pen that utilizes an LED luminary to emit a stream of light passing through a taper arc opening with either a flat surface or an oblique surface formed thereon. Accordingly, the light would be shined on a detective surface, via which the light would be further reflected to a light sensor. Consequently, the light sensor thence receives a designated image, and the action of receiving is recorded. When a pen pipe is moved, the moving track would be recorded as a group of serial images that are shot under a high speed. Subsequently, a set of chip for image analysis would be employed to analyze and process the shot serial images on the moving track. By analyzing the variation of feature points of the images, the moving direction and distance could be established, so that the orientation of a cursor could be accomplished by the establishment of a designated positive position. Alternatively, a G-sensor is applied to sense the variation of acceleration, which is defined as the power acted on an object when the object is speeded up. Herein, the moving variation could be all converted into digital signals. For example, a first inclination θ₁ between an axis of the pen and gravity and a second inclination θ₂ generated while spinning and levelly moving the axis of the pen in time of gripping the pen could be counted and analyzed by a software in the circuit board with the micro processor. Thereby, a compensation of a rotative coordinate could be accomplished in accordance with moving values from the X axis and the Y axis of the LED luminary and the light sensor. Hence, the moving direction and distance would not be influenced however the pen pipe is moved. Therefore, the orientation of the cursor is achieved. Favorably, user's finger could touch the touch board module and move thereon; concurrently, the screen could be accordingly controlled and scrolled upward and downward, which functions as the roller on the mouse. At the same time, by pressing an up-down event module by another finger, the screen could be thence controlled by the control command, which functions as the click buttons on the mouse. Finally, the digital signals generated from the mouse pen would be emitted to the circuit board with the micro processor via a wireless emitting module, and thence a wireless transmission of the signal to an outer electronic device could be received by a wireless receiving module. Thus, the mouse pen could execute the related command or software in correspondence with an outer electronic device. In addition, the cursor could be favorably controlled even only a limited area of scope is provided. Therefore, the mouse pen is user-friendly and beneficial for handy portability.
B. Another object of the present invention is to provide a mouse pen that could be favorably applied according to users' gripping habits. Namely, the left-handed person could set the up-down event module as the positive position, and the touch board module could be thence set at the right side of the up-down event module. Oppositely, the right-handed person could set two touch board modules at both sides of the up-down event module to preferably offer a practicability of providing dual purposes. Moreover, the arrangements of the up-down event module and the touch board module could be alternatively switched. That is to say, the touch board module could be disposed at the positive position and the up-down event module could be disposed at the right side, the left side, or both sides of the touch board module. Whereby, a same dual purpose could be consistently provided.
C. The other object of the present invention is to provide a mouse pen utilizing a laser luminary or a laser Doppler to replace an LED luminary for combining with a light sensor. In view of the high illumination, superior orientation, and high monochromaticity provided by the laser luminary, the mouse pen and the detective surface would not maintain a vertical angle or a fixed inclination. Nonetheless, the same reflection could be still achieved. Moreover, the laser Doppler could decrease the delay problem and increase the scope of the detective surface, so that the precision of the mouse pen is promoted, and the favorable using efficiency is achieved.

### BRIEF DESCRIPTION OF THE DRAWINGS

FIG. 1 is a cross-sectional view of a first preferred embodiment of the present invention;

FIG. 2 is another cross-sectional view of the first preferred embodiment;

FIG. 2-A is another cross-sectional view of the first preferred embodiment;

FIG. 3 is a schematic view showing a second preferred embodiment of the present invention in using;

FIG. 4 is a block diagram showing a third preferred embodiment of the present invention;

FIG. 5 is a cross-sectional view showing the third preferred embodiment;

FIG. 6 is another cross-sectional view showing the third preferred embodiment;

FIG. 7 is a schematic view showing the third preferred embodiment in using;

FIGS. 7-8 are schematic view showing coordinates of a light sensor and a G-sensor of the present invention;

FIG. 10 is a schematic view showing an inclination between a G gravity and the G-sensor; and

FIG. 10-A is a schematic view showing an inclination between the G gravity and the light sensor.

### DETAILED DESCRIPTION OF THE PREFERRED EMBODIMENTS

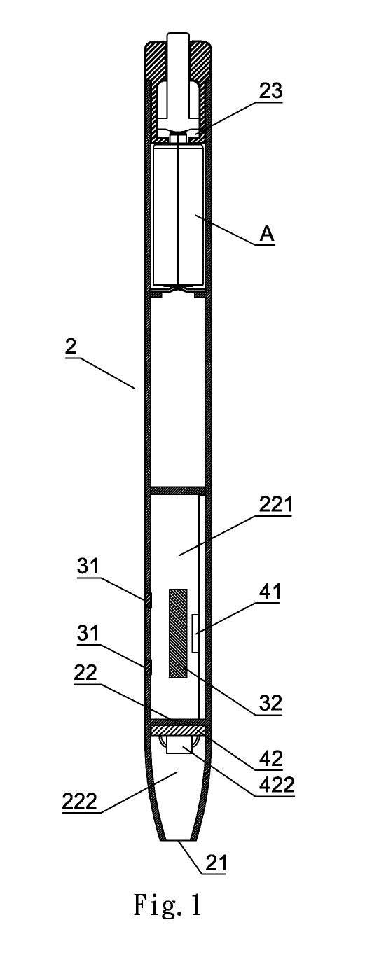

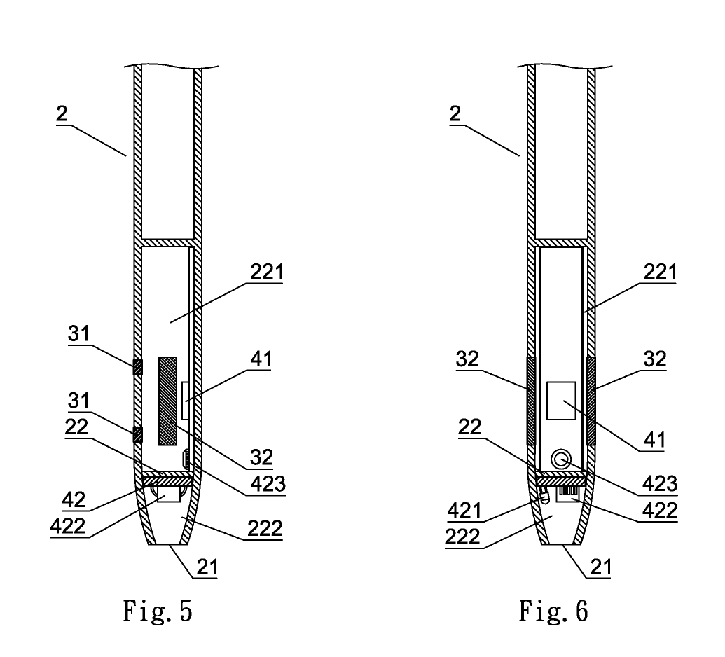

Referring to FIGS. 1, 4, and 5 show the present invention comprising the following elements:

A pen pipe 2 forming a hollow body with a taper arc opening 21 at its front end. Wherein, the taper arc opening 21 could be optionally formed with an oblique surface or a flat surface for serving as designated positive or non-designated positive. An inner front of the hollow body is divided into an accommodation 221 and a track space 222 by a spacer 22. Further, a touch device 3 and a controlling circuit 4 are installed in the accommodation 221 and the track space 222. In addition, an inner rear of the hollow body provides with a battery module 23, which adopts either an alkaline battery A, a lithium battery, or a rechargeable battery for serving as main electricity, so that a incessant power could be consistently supplied.

A touch device 3 includes an up-down event module 31 disposed at a positive position relative to the accommodation 221 of the pen pipe 2 for being touched and controlled by users' forefingers. Wherein, the up-down event module 31 could adopt click buttons for meeting different requirements of multiple users. A touch board module 32 is disposed at either a right side or a left side of the up-down event module 31 for being touched and controlled by a users' thumbs. Accordingly, the touch board module 32 is served as a roller on the mouse.

A control circuit 4 mainly controls a circuit board with a micro processor 41. Wherein, the battery module 23, the touch device 3, and a detective module 42 are connected to the controlling circuit 4. The detective module 42 is formed by a combination of an LED luminary 421 (or a laser luminary (LD)/laser Doppler) and a light sensor 422 fixed under the spacer 22 inside the track space 222. Alternatively, the detective module 42 could be also formed by an LED luminary 421/laser luminary/laser Doppler and a light sensor 422 as well as a G-sensor 423 combined together to detect signals on a moving track. Wherein, the G-sensor 423 is disposed on the circuit board with the micro processor 31. Thereby, the present invention merely needs a small operational area and achieves a convenient using effect.

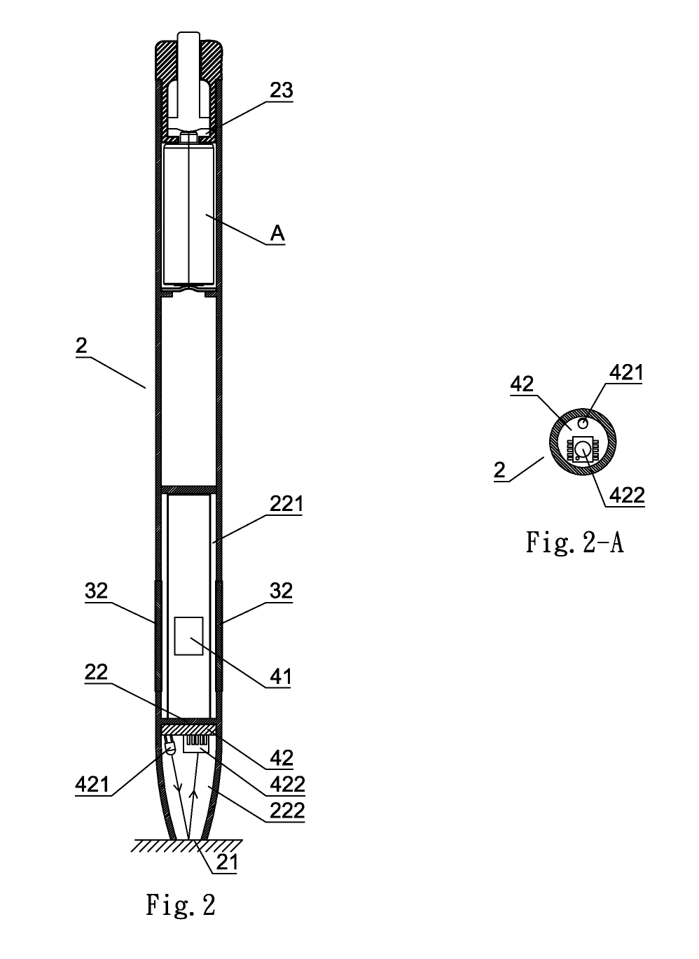

Referring to FIGS. 1 to 2-A and 4, a first preferred embodiment of the present invention showing the detective module 42 is formed by the LED luminary 421 and the light sensor 422. Moreover, the up-down event module 31 is selected to be a designated positive position. The LED luminary 421 emits a stream of light passing through the taper arc opening 21 formed with a flat surface, so that the detective surface would be accordingly shone by the light. Whereby, the light would be thence reflected to the light sensor 422 via the detective surface. Consequently, the light sensor 422 thence receives a designated image, and the action of receiving is recorded. When the pen pipe 2 is moved, the moving track would be recorded as a group of serial images that are shot under a high speed. Subsequently, a set of chip for image analysis (DSP) would be employed to analyze and process the shot serial images on the moving track. By analyzing the variation of feature points of the images, the moving direction and distance could be determined, so that the orientation of a cursor could be established. Favorably, user's thumb could touch the touch board module 32 and move thereon; concurrently, the screen could be accordingly controlled and scrolled upward and downward, which functions as the roller on the mouse. At the same time, by pressing an up-down event module 31 by the forefinger, the screen could be thence controlled by the control command, which functions as the click buttons on the mouse. Finally, the digital signals generated from the mouse pen would be emitted to the circuit board with the micro processor 41, and thence a wireless emitting module 43 would employ a wireless transmission to an outer electronic device 5, so that the signal could be received by a wireless receiving module 51. Wherein, the wireless communication manner adopts the Bluetooth or the ultrared. Thereby, other related operational commands or software could be preferably controlled by the mouse pen cooperating with the outer electronic device 5. Nonetheless, the correspondent moving detection and counting presented by the detective module 42, and the related operational detail as well as the executive content performed by the touch board module 32 and the up-down event module 31 are herein omitted. Since the aforementioned techniques involved are well known by the skilled person in the art, detailed description is skipped, and the present invention still provides a cursor that merely needs a small operational area and is beneficial for portability.

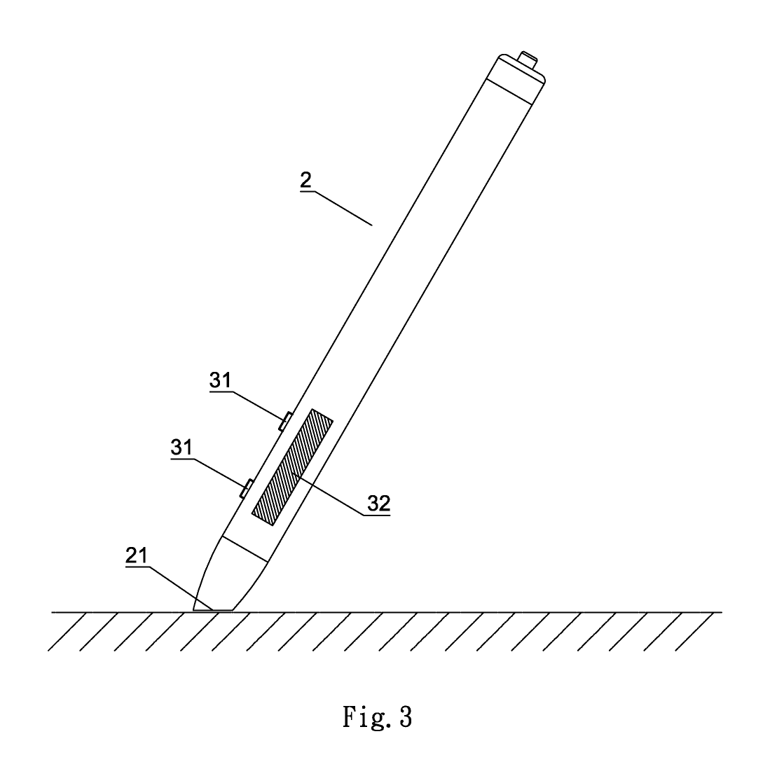

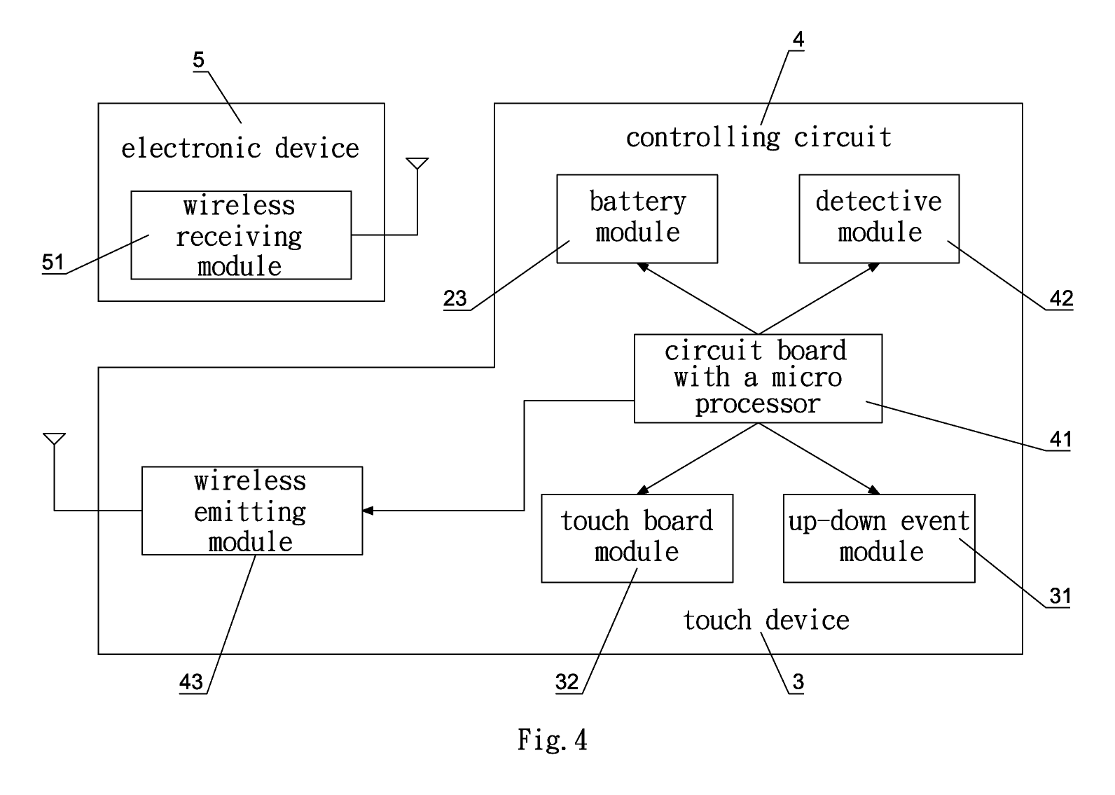

Referring to FIGS. 3 and 4 showing a second preferred embodiment of the present invention, the taper arc opening 21 originally designed with the flat surface is now adopting an oblique surface. In this manner, a user-friendly operation is provided by the inclination that clearly designates the positive position. Wherein, the using means and procedures are same as that of the first preferred embodiment.

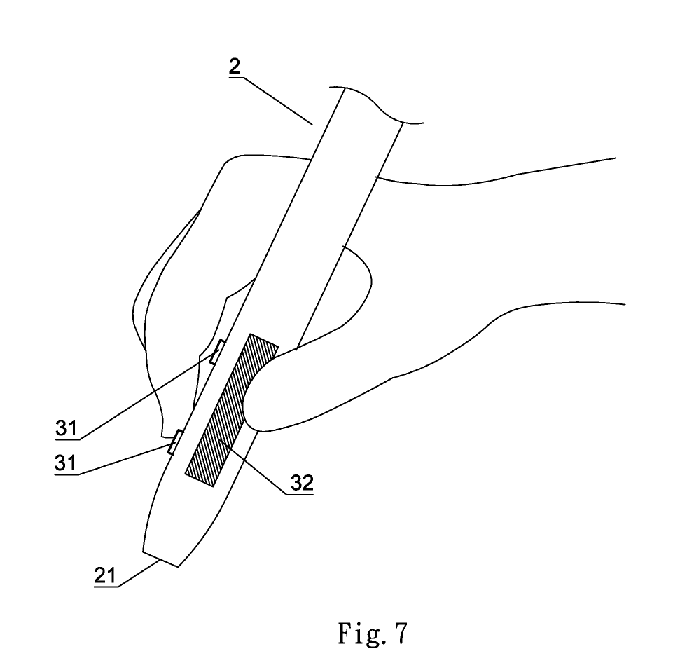

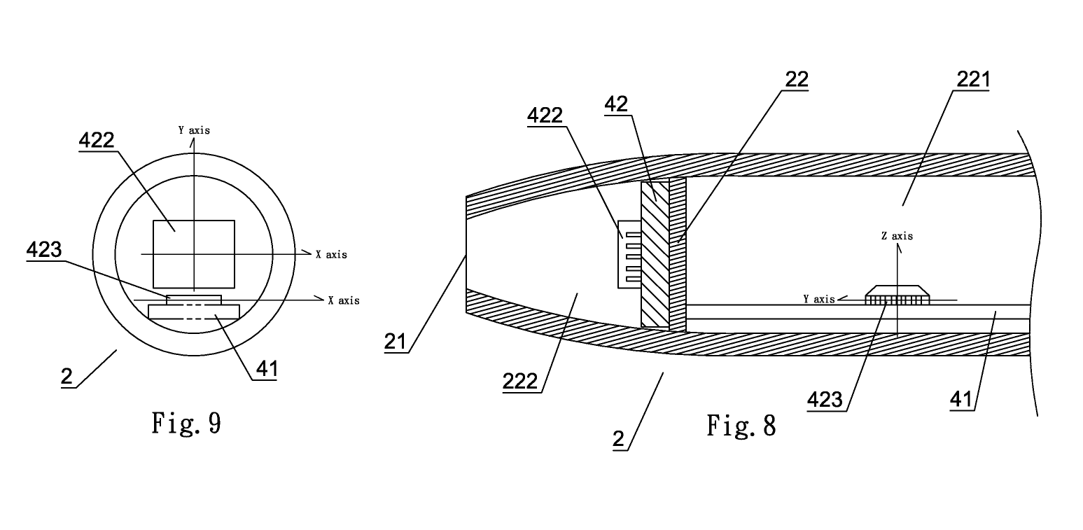

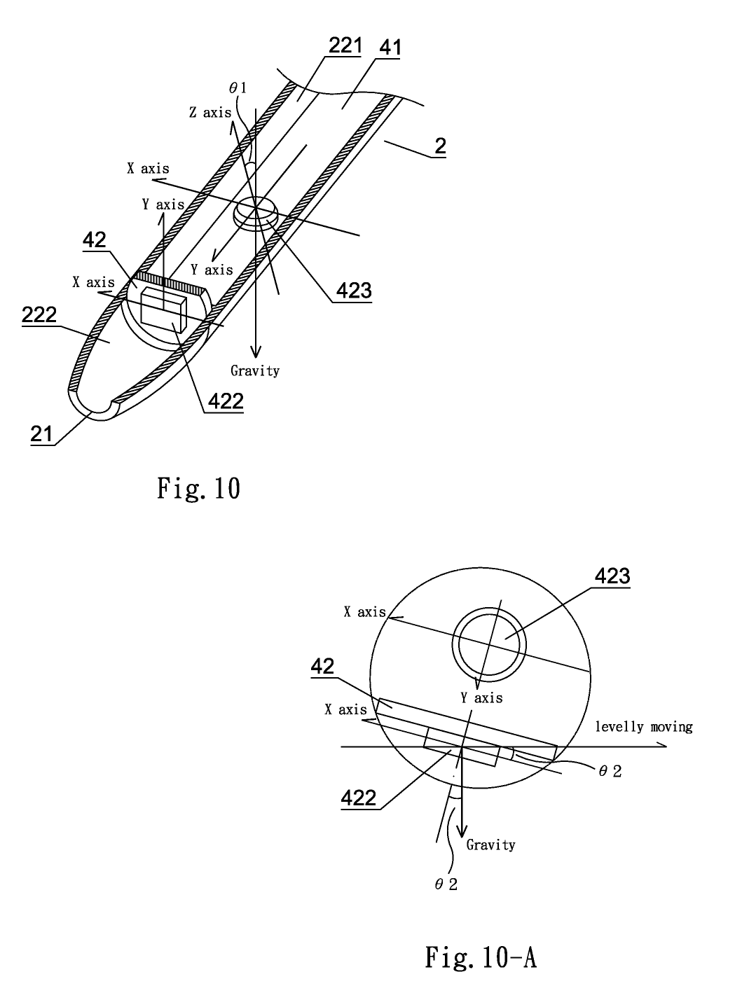

Further referring to FIGS. 4 to 10, and 10-A showing a third preferred embodiment of the present invention illustrate the detective module 34 formed by the LED luminary 341, the light sensor 342, and the G-sensor 343. Wherein, the G-sensor 343 is served for sensing the variation of acceleration, which is defined as the power acted on an object when the object is speeded up. Herein, the moving variation could be all converted into digital signals. For example, a first inclination 9′ (as shown in FIG. 10) between an axis of the pen and gravity and a second inclination θ₂ (as shown in FIG. 10-A) generated while spinning and levelly moving the axis of the pen in time of gripping the pen could be counted and analyzed by a software in the circuit board with the micro processor 41. Thereby, a compensation of a rotative coordinate could be accomplished in accordance with moving values from the X axis and the Y axis of the LED luminary 421 and the light sensor 422. Hence, the moving direction and distance would not be influenced however the pen pipe 2 is moved. Therefore, the orientation of the cursor is achieved. Favorably, user's finger could touch the touch board module 32 and move thereon; concurrently, the screen could be accordingly controlled and scrolled upward and downward, which functions as the roller on the mouse. At the same time, by pressing an up-down event module 31 by another finger, the screen could be thence controlled by the control command, which functions as the click buttons on the mouse. Finally, the digital signals generated from the mouse pen would be emitted to the circuit board with the micro processor 41, and thence the signal could be wirelessly transmitted through the wireless emitting module 43 for the wireless receiving module 51 of the outer electronic device 5 to receive. Thus, the mouse pen could execute the related command or software in correspondence with the outer electronic device 5. In addition, the cursor could be favorably controlled even only a limited area of scope is provided. Therefore, the mouse pen is beneficial for practical control and handy portability.

Referring to FIGS. 1, 3, and 7, the present invention provides the mouse pen that could be favorably applied according to users' gripping habits. Namely, the left-handed person could set the up-down event module 31 as the positive position, and the touch board module 32 could be thence set at the right side of the up-down event module 31. Oppositely, if the right-handed person set the up-down event module 31 as the positive position, the touch board module 32 would be thence disposed at the left side of the up-down event module 31. Alternatively, two touch board modules 32 could be preferably disposed at both sides of the up-down event module 31 to offer a practicability by dual purpose. Moreover, the arrangements of the up-down event module 31 and the touch board module 32 could be optionally switched. That is to say, the touch board module 32 could be disposed at the positive position and the up-down event module 31 could be disposed at the right side, the left side, or both sides of the touch board module 32. Whereby, a same dual purpose could be favorably provided.

Referring to FIGS. 2, 4, and 6, the present invention utilizes the laser luminary (LD)/laser Doppler (that employs light wave, sound wave, or electric wave to execute the detection manner) to replace the LED luminary 421 for combining with the light sensor 422. In view of the high illumination, superior orientation, and high monochromaticity provided by the laser luminary, the mouse pen and the detective surface would not maintain a vertical angle or a fixed inclination. Nonetheless, the same reflection could be still achieved. Moreover, the laser Doppler could decrease the delay problem and increase the scope of the detective surface, so that the precision of the mouse pen is promoted, and the favorable using efficiency is achieved.

To sum up, the present invention provides a mouse pen for being operated within a small operational area; concurrently, the benefits with the conventional mouse are still preferably maintained.

### DESCRIPTION OF ELEMENTS IN THE DRAWINGS

2 pen pipe
22 spacer
222 track space
3 touch device
32 touch board module
41 circuit board with a micro processor
42 detective module
422 light sensor
43 wireless emitting module
51 wireless receiving module
21 taper arc opening
221 accommodation
23 battery module
31 up-down event module
4 controlling circuit
421 LED luminary
423 G-sensor
5 electronic device
A alkaline battery

I claim:

1. A mouse pen comprising:
a pen pipe forming a hollow body with a taper arc opening at its front end; an inner front of said hollow body being divided into an accommodation and a track space by a spacer; an inner rear of said hollow body providing with a battery module;
a touch device including an up-down event module disposed at a positive position of said accommodation for being touched and controlled by users' forefingers; a touch board module being disposed at either a right side, a left side, or both sides of said up-down event module for being touched and controlled by users' thumbs; and
a control circuit mainly controlling a circuit board with a microprocessor; wherein, said battery module, said touch device, and a detective module being connected to said controlling circuit; said detective module being formed by a combination of an LED luminary and a light sensor fixed under said spacer inside said track space;
a detection of a moving signal detected by said detective module that is installed in said track space and an establishment of said designated positive position would cooperate with an auxiliary function and an executive command provided from said touch board module that is engaged with said accommodation as well as from said up-down event module, so that said circuit board with said micro processor would process said function and said command to wirelessly emit the same to an outer electronic device, thereby a cursor and other related operation on a monitor could be controlled; a demand for operating said mouse on a smaller area being achieved, and said mouse could be conveniently portable.

2. A mouse pen as claimed in claim 1, wherein, said taper arc opening could be formed either with an oblique surface for a designated positive position or with a flat surface for a non-designated positive position.

3. The mouse pen as claimed in claim 1, wherein, said up-down event module adopts click buttons.

4. The mouse pen as claimed in claim 1, wherein, said battery module adopts either an alkaline battery, a lithium battery, or a rechargeable battery for serving as main electricity.

5. The mouse pen as claimed in claim 1, wherein, a wireless communication adapted to said circuit board with said micro processor adopts the Bluetooth or the ultrared.

6. The mouse pen as claimed in claim 1, wherein, said LED luminary adopts a laser luminary or a laser Doppler.

7. The mouse pen as claimed in claim 1, wherein, said up-down event module is defined at said positive position, and said touch board module is defined at a right side, a left side, or both sides.

8. The mouse pen as claimed in claim 1, wherein, said touch board module is defined at said positive position, and said up-down event module is disposed at a right side, a left side, or both sides of said touch board module.

9. A mouse pen comprising:
a pen pipe forming a hollow body with a taper arc opening at its front end; an inner front of said hollow body being divided into an accommodation and a track space by a spacer; an inner rear of said hollow body providing with a battery module;
a touch device including an up-down event module disposed at a positive position of said accommodation for being touched and controlled by users' forefingers; a touch board module being disposed at either a right side, a left side, or both sides of said up-down event module for being touched and controlled by users' thumbs; and
a controlling circuit mainly controlling a circuit board with a micro processor, and said controlling circuit being connected to said battery module, said touch device, and a detective module; said detective module being formed by an LED luminary and a light sensor as well as a G-sensor that are combined and respectively disposed under said spacer inside said track space and above said circuit board with said micro processor;
a detection of a moving signal detected by said detective module installed in said track space and an establishment of said designated positive position would cooperate with an auxiliary function and an executive command provided from said touch board module that is engaged with said accommodation as well as from said up-down event module, so that said circuit board with said micro processor would process afore function and command for offering a coordinate with a rotative compensation to wirelessly emit the same to an outer electronic device; thereby, a cursor's moving and other related operation on a screen would not be influenced by a rotary motion from said pen pipe; a demand for applying said mouse to a smaller area being achieved, and said mouse could be conveniently portable.

10. The mouse pen as claimed in claim 9, wherein, said up-down event module adopts click buttons.

11. The mouse pen as claimed in claim 9, wherein, said battery module adopts either an alkaline battery, a lithium battery, or a rechargeable battery for serving as main electricity.

12. The mouse pen as claimed in claim 9, wherein, a wireless communication adapted to said circuit board with said micro processor adopts the Bluetooth or the ultrared.

13. The mouse pen as claimed in claim 9, wherein, said LED luminary adopts a laser luminary or a laser Doppler.

14. The mouse pen as claimed in claim 9, wherein, said up-down event module is defined at said positive position, and said touch board module is defined at a right side, a left side, or both sides of said up-down event module.

15. The mouse pen as claimed in claim 9, wherein, said touch board module is defined at said positive position, and said up-down event module is disposed at a right side, a left side, or both sides of said touch board module.
